(19) United States
(12) Patent Application Publication
(10) Pub. No.: US 2024/0356045 A1
(43) Pub. Date: Oct. 24, 2024

(54) ELECTROCHEMICAL CELL STACK INTERCONNECTS HAVING COPPER CONTAINING PROTECTIVE LAYERS AND METHOD OF MAKING THEREOF

(71) Applicant: BLOOM ENERGY CORPORATION, San Jose, CA (US)

(72) Inventors: Tad ARMSTRONG, Burlingame, CA (US); Zigui LU, San Jose, CA (US); Guoliang XIAO, Fremont, CA (US); Keji PAN, Pleasanton, CA (US); Nicholas Ryan GEISENDORFER, San Jose, CA (US); Thuy Thanh MUHL, San Jose, CA (US)

(21) Appl. No.: 18/640,490

(22) Filed: Apr. 19, 2024

Related U.S. Application Data
(60) Provisional application No. 63/497,529, filed on Apr. 21, 2023.

(51) Int. Cl. H01M 8/0228; C25B 9/77; C25B 13/07; H01M 8/0217; H01M 8/12

(52) U.S. Cl. CPC H01M 8/0228; C25B 9/77; C25B 13/07; H01M 8/0217; H01M 2008/1293

(57) ABSTRACT

An interconnect for an electrochemical cell stack, the interconnect including an interconnect substrate having an air side and an opposing fuel side, and a protective layer coated on at least the air side of the interconnect, the protective layer including a transition metal oxide including copper (Cu) and at least one of iron (Fe) and manganese (Mn).

### FIELD

Aspects of the present disclosure relate generally to spinel protective layer compositions for electrochemical cell stack (e.g., fuel cell stack or electrolyzer stack) interconnects, and in particular, to copper containing spinel protective layer compositions.

### BACKGROUND

A typical solid oxide fuel cell stack includes multiple fuel cells separated by metallic interconnects (IC) which provide both electrical connection between adjacent cells in the stack and channels for delivery and removal of fuel and oxidant. The metallic interconnects are commonly composed of a Cr-based alloys such as CrFe alloys, which have a composition of 95 weight percent (“wt. %”) Cr-5 wt. % Fe or Cr—Fe—Y having a 94 wt. % Cr-5 wt. % Fe-1 wt. % Y composition. The CrFe and CrFeY alloys retain their strength and are dimensionally stable at typical solid oxide fuel cell (SOFC) operating conditions, e.g., 700-900° C. in both air and wet fuel atmospheres.

### SUMMARY

According to various embodiments, an interconnect for an electrochemical cell stack comprises: an interconnect substrate having an air side and an opposing fuel side; and a protective layer coated on at least the air side of the interconnect substrate, the protective layer comprising a transition metal oxide comprising copper (Cu) and at least one of iron (Fe) and manganese (Mn).

According to various embodiments, a method of making an interconnect for an electrochemical cell stack comprises providing interconnect substrate having an air side and an opposing fuel side; and forming a protective layer on at least the air side of the interconnect substrate, the protective layer comprising a transition metal oxide comprising copper (Cu) and at least one of iron (Fe) and manganese (Mn).

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a perspective view of an electrochemical cell stack, according to various embodiments of the present disclosure.

FIG. 1B is a cross-sectional view of a portion of the stack of FIG. 1A.

FIG. 2A is a top view of an air side of an interconnect, according to various embodiments of the present disclosure.

FIG. 2B is a top view of a fuel side of the interconnect of FIG. 2A.

FIG. 3 is a three dimensional view of an electrochemical cell column, according to various embodiments of the present disclosure.

FIG. 4A is a scanning electron microscopy (SEM) micrograph of a protective layer formed on an interconnect, according to various embodiments of the present disclosure.

FIG. 4B includes energy dispersive X-ray spectroscopy (EDS) images of the structure of FIG. 4A.

FIG. 5A is a scanning electron microscopy (SEM) micrograph of a protective layer formed on an interconnect, according to various embodiments of the present disclosure.

FIG. 5B includes energy dispersive X-ray spectroscopy (EDS) images of the structure of FIG. 5A.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochemical cell systems include fuel cell and electrolyzer cell systems. In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow can be a hydrogen (H₂) or a hydrocarbon fuel, such as methane, natural gas, ethanol, or methanol. The fuel cell, operating at a typical temperature between 750° C. and 950° C., enables the transport of negatively charged oxygen ions from the cathode flow stream to the anode flow stream, where the ions combine with either free hydrogen or hydrogen in a hydrocarbon molecule to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit. In an electrolyzer system, such as a solid oxide electrolyzer system, water (e.g., steam) is separated into hydrogen and oxygen by applying a voltage across the electrolyzer cells.

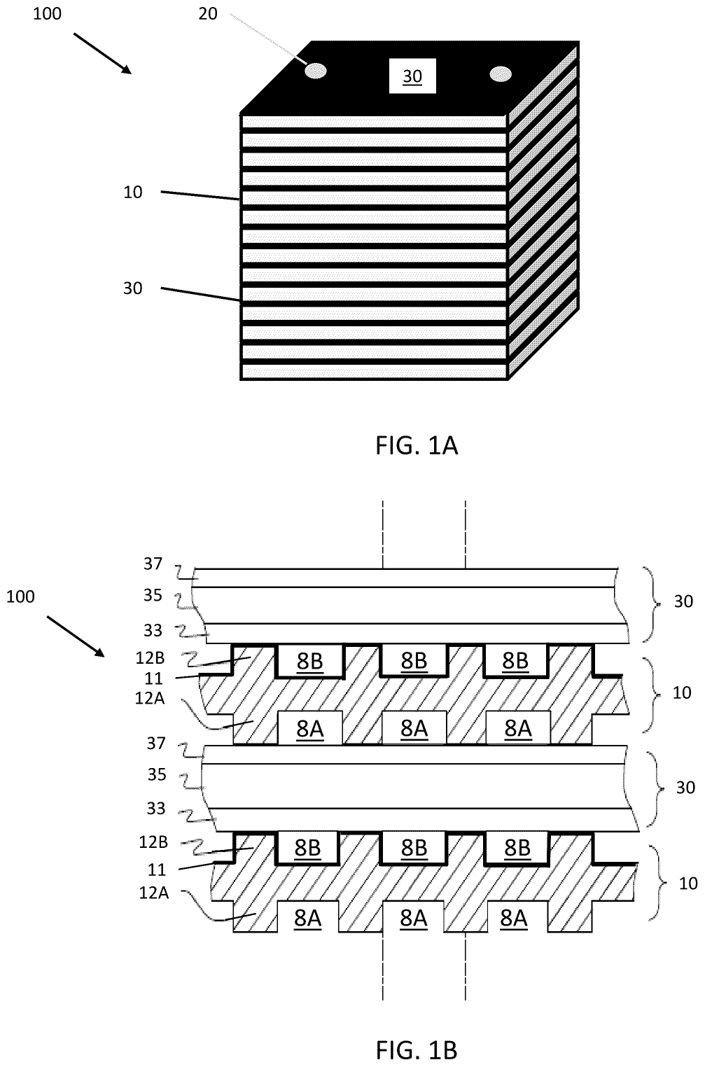

FIG. 1A is a perspective view of an electrochemical cell stack 100 and FIG. 1B is a sectional view of a portion of the stack 100, according to various embodiments of the present disclosure. In the embodiments below, the stack 100 is described as being operated as a solid oxide fuel cell (SOFC) stack 100. However, it should be noted that the stack 100 may also be operated as an electrolyzer (e.g., a solid oxide electrolyzer cell (SOEC) stack). Referring to FIGS. 1A and 1B, the stack 100 includes fuel cells 30 separated by interconnects 10 (i.e., interconnect substrates that may have a coating on one or both sides). Referring to FIG. 1B, each fuel cell 30 comprises a cathode electrode 33, a solid oxide electrolyte 35, and an anode electrode 37.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in addition to nickel and/or nickel alloys. The ceramic phase may comprise a stabilized zirconia, such as yttria and/or scandia stabilized zirconia and/or a doped ceria, such as gadolinia, yttria and/or samaria-doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above described materials.

Fuel cell stacks 100 are frequently built from a multiplicity of SOFC's 30 in the form of planar elements, tubes, or other geometries. Although the fuel cell stack in FIG. 1A is vertically oriented, fuel cell stacks may be oriented horizontally or in any other direction. Fuel and air may be provided to the electrochemically active surface, which can be large. For example, fuel may be provided through fuel holes 20 formed in each interconnect 10. The fuel holes 20 may be aligned to form fuel conduits (i.e., fuel riser openings) that extend through the stack 100.

Each interconnect 10 electrically connects adjacent fuel cells 30 in the stack 100. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack.

The interconnects 10 may electrically connect the anode or fuel-side of one electrochemical cell (e.g., fuel cell) 30 to the cathode or air side of an adjacent electrochemical cell (e.g., fuel cell) 30 in the stack. Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may each include a metallic substrate comprising a high-temperature stable metal alloy, such as a chromium-iron alloy, such as 4-6 weight percent (“wt. %”) iron, optionally 1 or less weight percent yttrium, and a balance (e.g., 94-96 wt. %) of chromium. Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe).

An electrically conductive contact layer, such as a nickel layer or mesh, may be provided between anode electrodes 37 and a fuel side of each interconnect 10. An electrically conductive protective layer 11, as described in detail below, may be provided on at least an air side of each interconnect 10.

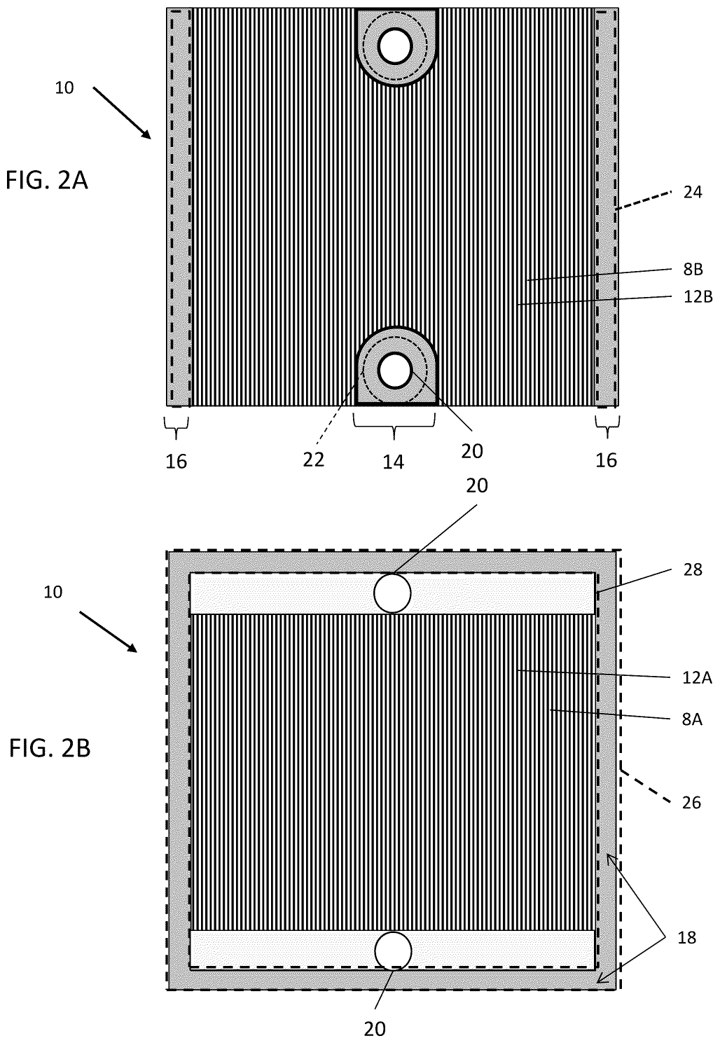

FIG. 2A is a top view of the air side of the interconnect 10, and FIG. 2B is a top view of a fuel side of the interconnect 10, according to various embodiments of the present disclosure. Referring to FIGS. 1B and 2A, the air side includes the air channels 8B. Air flows through the air channels 8B to a cathode electrode 33 of an adjacent fuel cell 30. The interconnect 10 may include ring seal regions 14 and strip seal regions 16. The seal regions 14, 16 may be flat surfaces that are coplanar with the tops of the air ribs 12B. Fuel holes 20 may be formed in the ring seal regions 14 and may extend through the interconnect 10. Ring seals 22 may be disposed on the ring seal regions 14 surrounding the fuel holes 20, to prevent fuel from contacting an adjacent cathode electrode 33. Strip seals 24 may be disposed on the strip seal regions 16. The seals 22, 24 may be formed of a glass or glass-ceramic material. The strip seal regions 16 may be an elevated plateau which does not include ribs or channels.

Referring to FIGS. 1B and 2B, the fuel side of the interconnect 10 may include the fuel channels 8A and fuel manifolds 28, which are surrounded by a frame seal region 18. The frame seal region 18 may be a flat region that is coplanar with the tops of the air ribs 12A. Fuel flows from one of the fuel holes 20 (e.g., inlet hole that forms part of the fuel inlet riser), into the adjacent manifold 28, through the fuel channels 8A, and to an anode 37 of an adjacent fuel cell 30. Excess fuel may flow into the other fuel manifold 28 and then into the other (e.g., outlet) fuel hole 20. A frame seal 26 may be disposed on the frame seal region 18. The frame seal 26 may be formed of a glass or glass-ceramic material.

Fuel is delivered through one of the fuel holes 20 to a corresponding manifold 28 that distributes the fuel to each fuel channel 8A. Fuel flows down each fuel channel 8A. Any unreacted fuel is collected in the other manifold 28 and exits the stack via the other fuel hole 20. This flow channel geometry may be optimized for operation on natural gas with partial external pre-reforming.

While a co-flow or counter-flow interconnect 10 is illustrated in FIGS. 2A and 2B, in alternative embodiments, the interconnect 10 may comprise a cross-flow interconnect in which the air and fuel channels extend perpendicular to each other, as described in U.S. Pat. No. 11,355,762 B2, which is incorporated herein by reference in its entirety. For example, such interconnects 10 may include two or more fuel holes 20 per side of the interconnect.

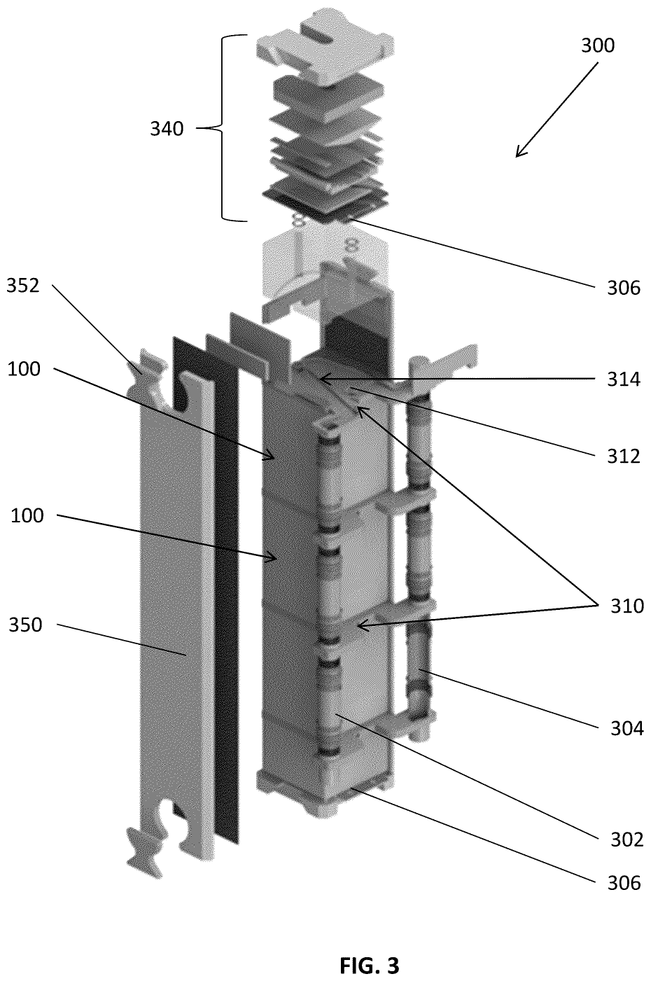

FIG. 3 is a perspective view of a fuel cell column 300, according to various embodiments of the present disclosure. Referring to FIG. 3, the fuel cell column 300 may include multiple fuel cell stacks 100, a fuel inlet conduit 302, an anode exhaust conduit 304, termination plates 306, and fuel manifolds 310 (e.g., anode splitter plates). The fuel inlet conduit 302 is fluidly connected to the fuel manifolds 310 and is configured to provide the fuel feed to each fuel manifold 310, and anode exhaust conduit 304 is fluidly connected to the fuel manifolds 310 and is configured to receive anode fuel exhaust from the fuel manifolds 310.

The fuel manifolds 310 may be disposed between the stacks 100 and may be configured to provide a fuel feed to the stacks 100 and to receive anode fuel exhaust from the stacks 100. For example, the fuel manifolds 310 may be fluidly connected to internal fuel riser channels formed by aligning the fuel holes 20 of the interconnects 10, as discussed above. In particular, the fuel manifolds 310 may include fuel holes 312 that are vertically aligned with the fuel riser channels/fuel holes 20, and fuel channels 314 that fluidly connect the fuel holes 312 with the respective fuel inlet conduit 302 and the anode exhaust conduit 304. In an alternative embodiment, the external fuel inlet conduit 302, the external anode exhaust conduit 304, and the fuel manifolds 310 may be omitted, as described in U.S. Pat. No. 11,355,762 B2, which is incorporated herein by reference in its entirety.

The fuel cell column 300 may also include a compression assembly 340 and side baffles 350 disposed on opposing sides of the fuel cell stacks 100. The side baffles 350 may be formed of a ceramic material and may be connected to the compression assembly 340 and an underlying stack component (not shown) by ceramic connectors 352. The compression assembly 340 may be configured to apply pressure to and/or compress the stacks 100, so as to seal the stacks 100 to adjacent components (e.g., the fuel manifolds 310).

Each stack 100 may include any suitable number of interconnects 10, such as from 5 to 40 interconnects 10, or from 10 to 35 interconnects 10, and a corresponding number of fuel cells 30 disposed therebetween.

### Protective Layer Compositions

Interconnect protective layers including a composite of LSM and manganese cobalt oxide (MCO) may form effective chromium diffusion barriers. However, the demand for cobalt has dramatically increased, due to recent increases in lithium ion battery production. As a result, cobalt has become increasingly expensive and difficult to source. As such, there is a need for cobalt-free protective layers that provide effective chromium barriers in electrochemical cell systems.

According to various embodiments, the protective layer 11 may comprise at least one transition metal oxide that comprises copper (Cu) and at least one of iron (Fe) or manganese (Mn). The transition metal oxide may be present in the protective layer 11 as a spinel phase. Spinels may have a formula AB₂X₄ (or slightly non-stoichiometric variations thereof) having a cubic (isometric) crystal system, with the X anions (typically chalcogens, such as oxygen) arranged in a cubic close-packed lattice, and the metal cations A and B occupying some or all of the octahedral and tetrahedral sites in the lattice.

In various embodiments, the protective layer 11 may include a spinel phase comprising a transition metal oxide represented by the general formula (Cu, M)₃O₄, wherein M comprises at least one of Fe or Mn, and optionally also contains an additional metal, such as excess copper. In one embodiment, the transition metal oxide is represented by the formula: Cu₍ₓ₊₁₎M₍₂₋ₓ₎O₄ or Cu₍ₓ₋₁₎M₍₂₊ₓ₎O₄, wherein M comprises at least one of Fe or Mn, and 0≤x≤1. When x=0, the formula reduces to CuM₂O₄. When x>0 and Cu₍₁₊ₓ₎M₍₂₋ₓ₎O₄, excess copper may be present on the M lattice sites. When x>0 and Cu₍₁₋ₓ₎M₍₂₊ₓ₎O₄, excess metal M (e.g., Fe) may be present on the copper lattice sites.

For example, the protective layer 11 may include spinel phase comprising a transition metal oxide represented by Formula 1: Cu₁₊ₓMn₂₋ₓO₄, wherein 0≤x≤1 or 0<x<1. One example of a spinel transition metal oxide of Formula 1 is CuMn₂O₄, which has high electron conductivity and good thermal stability.

In various embodiments, the protective layer 11 may include a spinel phase comprising a transition metal oxide represented by Formula 2: Cu₁₊ₓFe₂₋ₓO₄, wherein 0≤x≤1 including 0<x<1. One example of a spinel transition metal oxide of Formula 2 is CuFe₂O₄, which is stable and has acceptable electronic conductivity.

In various embodiments, the protective layer 11 may include a spinel phase comprising a transition metal oxide represented by Formula 3: CuFeₓMn₂₋ₓO₄, wherein 0≤x≤1 including 0<x<1. One example of a spinel transition metal oxide of Formula 3 is CuFe_{0.3}Mn_{1.7}O₄, which is believed to form CuMn₂O₄ and CuFe₂O₄ phases, with a relatively larger amount of the CuMn₂O₄ phase and a relatively smaller amount of the CuFe₂O₄ phase.

Another example of a spinel transition metal oxide of Formula 3 is CuFeMnO₄, which is believed to form a dual phase structure comprising a CuMn₂O₄ phase and a CuFe₂O₄ phase. It is believed that these phases are at least partially soluble in one another.

According to various embodiments, the protective layer 11 may include a spinel phase comprising a transition metal oxide represented by Formula 4: Cu₁₋ₓFeₓMn₂O₄, wherein 0≤x≤1 including 0<x<1. One example of a spinel transition metal oxide of Formula 4 is Cu_{0.5}Fe_{0.5}Mn₂O₄.

In some embodiments, the protective layer 11 may comprise y wt. % of a first one of the spinel transition metal oxides having the formula (Cu, M)₃O₄, and (100-y) wt. % of a second one of the spinel transition metal oxide having the formula (Cu, M)₃O₄, wherein 0<y<100%. For example, the protective layer 11 may comprise from about 20 wt. % to about 40 wt. % of a first spinel transition metal oxide and from about 60 wt. % to about 80 wt. % of a second spinel transition metal oxide, based on a total weight of spinel transition metal oxides included in the protective layer 11. In some embodiments, the protective layer 11 may comprise 30% CuMn₂O₄ and 70% CuFe₂O₄, based on a total amount of spinel transition metal oxides included in the protective layer 11.

In various embodiments, the protective layer 11 may be a composite coating comprising at least one of the above transition metal oxides having the formula (Cu, M)₃O₄ and at least one perovskite material, such as an LSM or the like. For example, the protective layer 11 may include, based on a total weight of the protective layer 11, z wt. % of the transition metal oxide and (100-z) wt. % of a perovskite material, wherein z ranges from about 20 to 40 wt. %. For example, the protective layer 11 may include from 20 to 40 wt. % (Cu, M)₃O₄ (e.g., such as CuMn₂O₄) and from 60 to 80 wt. % LSM, such as 30 wt. % CuMn₂O₄ and 70 wt. % LSM.

In various embodiments, the protective layer 11 is cobalt-free. For example, the protective layer 11 may comprise less than 0.5 wt. % cobalt, such as less than 0.1 wt. % cobalt, or 0 to less than 0.05 wt. % cobalt, based on a total weight of the protective layer 11. Thus, by eliminating the expensive cobalt, the cost of the protective layer is reduced.

The protective layer 11 may optionally include a relatively small amount (e.g., less than 5 wt. %, such as from about 0.5 wt. % to about 3 wt. %) or of one or more adhesion promoting elements such as Mg, Y, Ce, La, Sm, and/or Zr, and/or oxides thereof, to increase the adhesion of the protective layer 11 to the oxide scale (e.g., native oxide, such as a chromium-containing oxide) of an interconnect substrate 10.

The protective layer 11 may be formed on at least the air side of the interconnects 10. However, in some embodiments, protective layers 11 may be applied to both the fuel side and the air side of the interconnects 10. The protective layer 11 may be applied to either a sintered interconnect 10 or to an un-sintered “green” interconnect.

The protective layer 11 may be formed by applying a protective layer material or a protective layer precursor material using any suitable coating method, such as a wet or dry coating process. Preferably, a protective layer material powder may be applied by a dry coating method, such as an atmospheric plasma spraying (APS). In particular, APS is believed to form a more uniform coating than wet coating processes.

In one embodiment, the atmospheric plasma spraying process comprises an air plasma spray process. In a plasma spray process, a feedstock powder is introduced into a plasma jet or spray, emanating from a plasma source, such as a plasma torch. The feedstock powder is melted in the plasma jet (where the temperature is over 8,000K) and propelled towards the interconnect substrate 10. There, the molten droplets flatten, rapidly solidify and form the protective layer 11.

Preferably, the feedstock powder comprises the metal powder having the same composition as the protective layer 11. For example, if the protective layer 11 comprises a (Cu, M)₃O₄ spinel layer, then a (Cu, M)₃O₄ powder is used as the APS feedstock powder. If the protective layer comprises a mixture of two different (Cu, M)₃O₄ spinel phases having different compositions, then the feedstock powder may comprise a blend of a first (Cu, M)₃O₄ powder and a second Cu, M)₃O₄ powder having a different composition than the first powder. If the protective layer comprises a mixed (Cu, M)₃O₄ and perovskite (e.g., LSM) layer, then the feedstock powder may comprise a blend of the (Cu, M)₃O₄ powder and the perovskite (e.g., LSM) powder. The individual powders may be pre-mixed in a blender, such as a V-blender, prior to the blended feedstock powders being provided into the plasma. In a V-blender, two cylinders having major axes diverging at an angle greater than 0 and less than 90 and joined together at a respective end are rotated about the horizontal axis to blend two powders together.

The feedstock powder (e.g., spinel powder or mixed spinel and perovskite powder) may have a median particle size between 10 and 50 microns. In one embodiment, the feedstock powder has the following particle size distribution: d10: 15 microns, d50: 25 microns, d75: 40 microns, d95: 45 microns.

The plasma may be generated by either direct current (e.g., electric arc DC plasma) or by induction (e.g., by providing the plasma jet through a center of an induction coil while a RF alternating current passes through the coil). The plasma may comprise a gas stabilized plasma (e.g., argon, helium, etc.). Preferably, the atmospheric plasma spraying is air plasma spraying which is performed in ambient air. Alternatively, a controlled atmosphere plasma spraying (CAPS) method may be used which is performed in a closed chamber, which is either filled with an inert gas or evacuated.

Preferably, the native oxide layer is removed from the interconnect substrate 10 prior to the deposition of the protective layer 11. For example, the native chromia layer may be removed from the CrFe substrate 10 by grinding, polishing, grit blasting, etching or other suitable methods before deposition of the protective layer, such that the native chromia does not substantially reform prior to the protective layer deposition.

If a mixed phase spinel and perovskite protective layer 11 is formed by APS, then the spinel and perovskite phases may be present as distinct regions in the composite protective layer 11. Without wishing to be bound by a particular theory, it is believed that the spinel phase may form plate-like or pancake-like (e.g., longer than thicker) structures (e.g., lamellae) which have a longer axis substantially parallel to (e.g., within 20 degrees of) the underlying surface of the interconnect substrate 10. The perovskite phase may either form a matrix or additional lamellae which alternate with the spinel phase lamellae in the protective layer 11.

The presence of crack-healing pancake-like spinel structures within the composite protective layer suppresses Cr evaporation through cracks generated in the perovskite phase. The presence of the perovskite phase stabilizes the composite protective layer in reducing atmospheres such that spallation does not occur and layer integrity is maintained.

In the alternative, a suspension comprising a protective layer material powder may be formed and applied to an interconnect 10 using a wet coating method, such as spraying (i.e., spray coating a powder suspension on the interconnects 10), screen printing, dip coating, or the like.

If necessary, an applied coating layer may be dried, sintered and/or oxidized. For example, wet coating methods in particular may require the use of drying, sintering, and/or oxidation steps in order to form a protective layer having a desired microstructure and/or density. In contrast, protective layers formed by APS may not require such processes to achieve a desired density and/or microstructure.

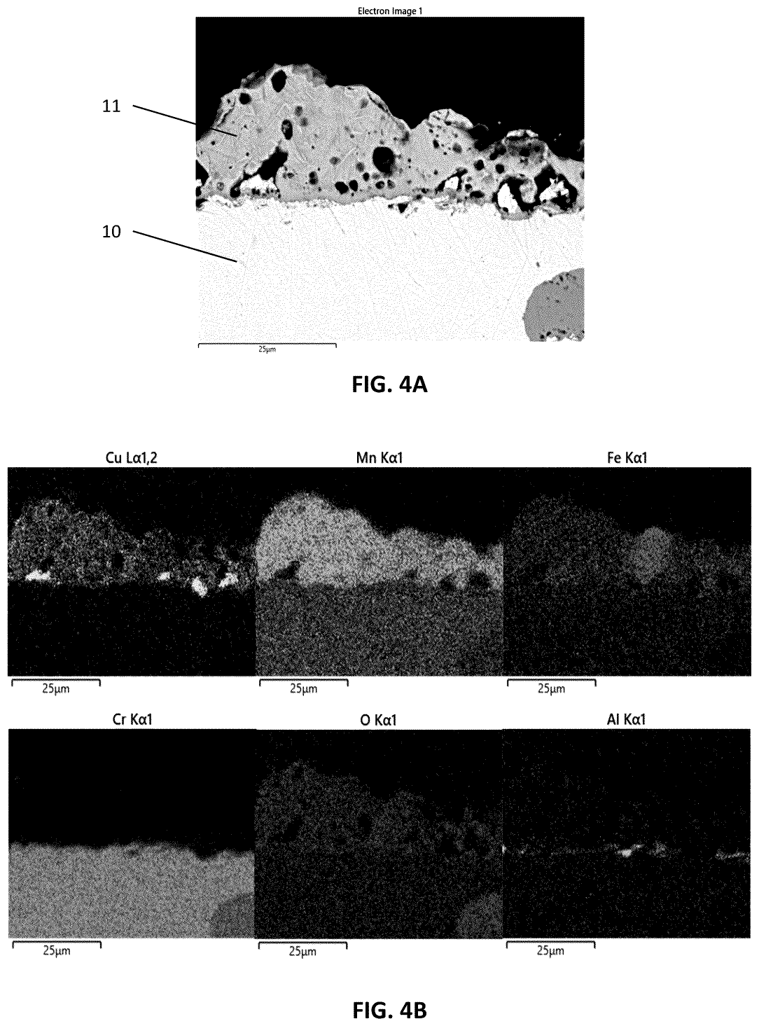

FIG. 4A is a scanning electron microscopy (SEM) micrograph of a protective layer 11 formed on an interconnect 10, according to various embodiments of the present disclosure. FIG. 4B includes energy dispersive X-ray spectroscopy (EDS) images of the structure of FIG. 4A.

Referring to FIG. 4A, the protective layer 11 comprised CuMn_{1.8}Fe_{0.2}O₄ and was formed by a wet spray process. The irregular morphology of the protective layer 11 was believed to be a result of the wet coating method. In addition, it is believed that forming the protective layer 11 using APS would result in a more uniform morphology.

Referring to FIGS. 4A and 4B, the Cr of the interconnect 11 did not appear to diffuse into the protective layer 11. As such, the CuMn_{1.8}Fe_{0.2}O₄ protective layer 11 was shown to operate as a Cr barrier. In addition, a significant amount of Cu and Fe diffusion from the protective layer 11 into the interconnect 10 was not observed.

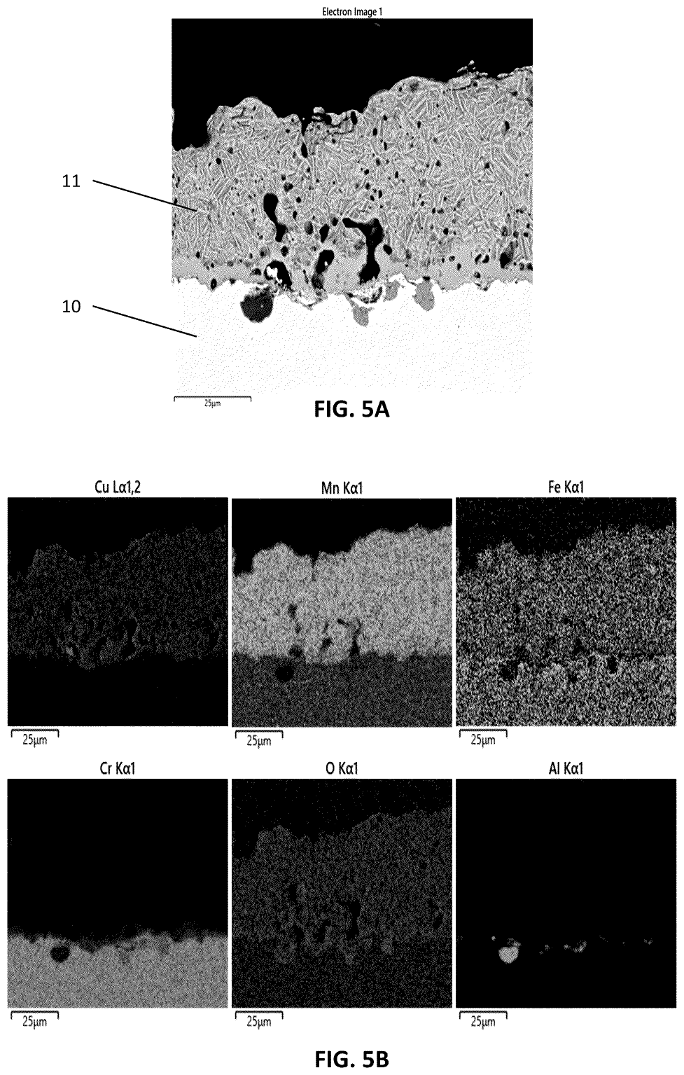

FIG. 5A is a scanning electron microscopy (SEM) micrograph of a protective layer 11 formed on an interconnect 10, according to various embodiments of the present disclosure. FIG. 5B includes energy dispersive X-ray spectroscopy (EDS) images of the structure of FIG. 5A.

Referring to FIG. 5A, the protective layer 11 comprised CuMn₂O₄ and was formed by a wet spray process. The irregular morphology of the protective layer 11 was believed to be a result of the wet coating method. In addition, it is believed that forming the protective layer 11 using APS would result in a more uniform morphology.

Referring to FIGS. 5A and 5B, a significant amount of the Cr of the interconnect 10 did not appear to diffuse into the protective layer 11. As such, the CuMn₂O₄ protective layer 11 was shown to operate as a Cr barrier. In addition, a significant amount of Cu diffusion from the protective layer 11 into the interconnect 10 was not observed.

According to various embodiments, the present inventors discovered that spinel transition metal oxides including Cu and at least one of Mn and/or Fe may unexpectedly be used in place of cobalt-containing spinel materials, such as MCO, while still providing excellent chromium diffusion resistance. Furthermore, the relatively expensive manganese may be partially or entirely replaced by less expensive iron in the spinel composition to further lower the cost of the protective layer 11.

Various embodiments may also provide additional benefits in comparison to conventional protective layer materials. For example, the presently disclosed protective layer materials may be easier to source and have a lower cost than conventional barrier layer materials.

Fuel cell systems of the embodiments of the present disclosure are designed to reduce greenhouse gas emissions and have a positive impact on the climate.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An interconnect for an electrochemical cell stack, the interconnect comprising:
an interconnect substrate having an air side and an opposing fuel side; and
a protective layer coated on at least the air side of the interconnect substrate, the protective layer comprising a transition metal oxide comprising copper (Cu) and at least one of iron (Fe) and manganese (Mn), wherein the protective layer comprises less than 0.5 wt. % cobalt (Co).

2. The interconnect of claim 1, wherein the transition metal oxide is represented by a formula: Cu₍ₓ₊₁₎M₍₂₋ₓ₎O₄ or Cu₍ₓ₋₁₎M₍₂₊ₓ₎O₄, wherein M comprises at least one of Fe or Mn, and 0≤x≤1.

3. The interconnect of claim 2, wherein the transition metal oxide is represented by the formula: Cu₁₊ₓMn₂₋ₓO₄, wherein 0≤x≤1.

4. The interconnect of claim 3, wherein the transition metal oxide comprises CuMn₂O₄.

5. The interconnect of claim 2, wherein the transition metal oxide is represented by a formula: Cu₁₊ₓFe₂₋ₓO₄, wherein 0≤x≤1.

6. The interconnect of claim 5, wherein the transition metal oxide comprises CuFe₂O₄.

7. The interconnect of claim 2, wherein the transition metal oxide is represented by a formula: CuFeₓMn₂₋ₓO₄, wherein 0≤x≤1.

8. The interconnect of claim 7, wherein the transition metal oxide comprises CuFe_{0.3}Mn_{1.7}O₄, CuFeMnO₄, or a combination thereof.

9. The interconnect of claim 7, wherein the transition metal oxide comprises CuMn₂O₄, CuFe₂O₄, or a combination thereof.

10. The interconnect of claim 2, wherein the transition metal oxide is represented by a formula: Cu₁₋ₓFeₓMn₂O₄, wherein 0≤x≤1.

11. The interconnect of claim 10, wherein the transition metal oxide comprises Cu_{0.5}Fe_{0.5}Mn₂O₄.

12. The interconnect of claim 2, wherein the protective layer comprises 0 to less than 0.05 wt. % of the cobalt.

13. The interconnect of claim 1, wherein the transition metal oxide comprises a spinel phase.

14. The interconnect of claim 1, wherein the protective layer further comprises a perovskite material.

15. The interconnect of claim 14, wherein the protective layer comprises, based on a total weight of the protective layer:
from 20 wt. % to 40 wt. % of the transition metal oxide; and
from 60 wt. % to 80 wt. % of the perovskite material.

16. The interconnect of claim 1, wherein the interconnect substrate comprises 4 to 6 wt. % iron and 94 to 96 wt. % chromium.

17. An electrochemical stack, comprising:
electrochemical cells; and
interconnects of claim 1 located between the electrochemical cells.

18. The electrochemical stack of claim 17, wherein the electrochemical cell stack is a fuel cell stack or an electrolyzer cell stack.

19. A method of making an interconnect for an electrochemical cell stack, comprising:
providing interconnect substrate having an air side and an opposing fuel side; and
forming a protective layer on at least the air side of the interconnect substrate, the protective layer comprising a transition metal oxide comprising copper (Cu) and at least one of iron (Fe) and manganese (Mn), wherein the protective layer comprises less than 0.5 wt. % cobalt (Co).

20. The method of claim 19, wherein:
the transition metal oxide comprises a spinel which is represented by a formula: Cu₍ₓ₊₁₎M₍₂₋ₓ₎O₄ or Cu₍ₓ₋₁₎M₍₂₊ₓ₎O₄, wherein M comprises at least one of Fe or Mn, and 0≤x≤1; and
the interconnect substrate comprises 4 to 6 wt. % iron and 94 to 96 wt. % chromium.

21. The method of claim 20, wherein the protective layer is formed by an atmospheric plasma spraying process.

22. The method of claim 21, further comprising blending a powder of the spinel with a perovskite powder to form a blended feed stock powder and providing the blended feedstock powder into a plasma jet.

23. The method of claim 22, wherein the protective layer comprises a composite protective layer comprising lamellae of the spinel phase which have a longer axis substantially parallel to an underlying surface of the interconnect substrate embedded in a perovskite phase matrix or alternating with perovskite phase lamellae.

24. The method of claim 21, wherein the atmospheric plasma spraying process comprises providing into a plasma jet a feedstock powder comprising the spinel having a following particle size distribution: d10: 15 microns, d50: 25 microns, d75: 40 microns, d95: 45 microns.
